(19) United States
(12) Patent Application Publication
(10) Pub. No.: US 2017/0027150 A1
(43) Pub. Date: Feb. 2, 2017

(54) Medication Rocker Shoe and Method

(71) Applicant: Monty L. Ruetenik, Clear Lake City, TX (US)

(72) Inventor: Monty L. Ruetenik, Clear Lake City, TX (US)

(21) Appl. No.: 15/274,350

(22) Filed: Sep. 23, 2016

Related U.S. Application Data
(63) Continuation-in-part of application No. 15/138,002, filed on Apr. 25, 2016.
Application No. 15/138,002 is a continuation-in-part of application No. 14/303,246, filed on Jun. 12, 2014, now abandoned.
Application No. 14/303,246 is a continuation-in-part of application No. 14/046,751, filed on Oct. 4, 2013, now abandoned.
Application No. 14/046,751 is a continuation-in-part of application No. 15/051,343, filed on Feb. 23, 2016.
(60) Provisional application No. 61/881,556, filed on Sep. 24, 2013.
(60) Provisional application No. 62/264,935, filed on Dec. 9, 2015.

(51) Int. Cl. A01L 15/00; A61D 7/00

(52) U.S. Cl. CPC A01L 15/00; A61D 7/00

(57) ABSTRACT

An equine solid structure, dual density, hoof shaped shoe structures to cover the entire underside of a hoof and has relatively small opening(s) to allow application of medication to the equine hoof after the shoe is attached. The shoe is sloped on the underside to allow the hoof to roll forward, or to the side, without unnecessary bending, thus allowing an equine to find a comfortable natural position to relieve stress on a sore, injured or diseased hoof. The solid shoe structure is has small openings (that are removably plugged) to allow medication or other components to be injected or inserted and is shaped to cover substantially the entire equine hoof underside.

### CROSS REFERENCE TO RELATED APPLICATIONS

This application is a continuation-in-part of U.S. application Ser. No. 15/138,002, filed Apr. 25, 2016 which is a continuation-in-part of U.S. application Ser. No. 14/303,246, filed Jun. 12, 2014 and is also a continuation-in-part application of U.S. application Ser. No. 14/046,751, filed Oct. 4, 2013 that claims priority to provisional application 61/881,556, filed Sep. 24, 2013 and is also a continuation-in-part application of U.S. application Ser. No. 15/051,343, filed Feb. 23, 2016 which claims priority to provisional application 62/264,935, filed Dec. 9, 2015. The contents and disclosures of each of these applications are incorporated herein by reference in their entirety for all purposes.

### BACKGROUND

Field of the Invention

This invention relates to equine shoes. More specifically if relates to an equine shoe structure and assembly that provides a cushioning effect on the hoof and legs, covers substantially all the underside of a hoof, provides a “rocker” break-over modification effect and allows access to the underside of the hoof without removing the shoe.

Background

Conventional equine shoes are bands of metal or hard polymer surrounding a large center opening. The bands are designed to attach under the walls of an equine hoof. Such shoes do not provide any cushioning of the hoof and leg. In some applications, where it is desirable to completely cover the underside of the hoof, fillers such as Equi-Pak™ are applied in the opening in the center of the shoe. Some solid shoes like “clogs” are also used. Both conventional shoes and “clogs” attached to the hoof by nailing into the hoof wall or by gluing. Conventional shoes provide little in the way of “break-over” modification and “clogs” provide no cushioning of the hoof. One commercial shoe that has found acceptance is sometime called a “banana” or “rocker” shoe or clog. This is a shoe that is shaped to allow break-over adjustment by a “rocker” effect of the sole of the hoof so that the horse can more easily find a comfortable position—by adjusting the palmar/planar angle to take pressure and stress off affected areas of the hoof. The “Clog” is a shoe developed by Dr. Micheal L. Steward, DVM of Oklahoma is one of the first to use the concept of a self-adjusting in a wooden shoe that is screwed and/or glued directly to the hoof. Adaptations of the Stewart Clog have been made of other materials. These shoes, while somewhat effective are attached directly to the hoof and are not easily changed without damage to the hoof. They do not allow access to the underside of the hoof when in place.

What is needed is a shoe that is stable, has a cushioning effect for the legs, covers substantially all the underside of a hoof, provides break-over modification and allows access to the underside of the hoof without removing the shoe. It is also desirable that the shoe may be applied by an owner or veterinarian without the need for a specialized farrier to “fit” the shoe. The present invention is a shoe assembly that provides these benefits.

### SUMMARY OF THE INVENTION

This invention is an equine solid structure, dual density, hoof shaped shoe that covers the entire underside of a hoof and has relatively small opening(s) to allow application of medication to the equine hoof after the shoe is attached. The shoe is sloped on the underside to allow the hoof to roll forward, or to the side, without unnecessary bending, thus allowing an equine to find a comfortable natural position to relieve stress on a sore, injured or diseased hoof. The solid shoe structure is has small openings (that are removably plugged) to allow medication or other components to be injected or inserted and is shaped to cover substantially the entire equine hoof underside. The structure is dual density construction with a relatively narrow hard section on the top section and a thicker softer section below, the harder component attaches to the hoof and acts to stabilize the softer lower section. Copper or other solid medical components may be bonded into the top side (side in contact with the hoof when in use). The invention is also a kit for providing comprising the described shoe and a method of treating diseased and sore equine hooves

### DESCRIPTION OF THE DRAWINGS

FIG. 1 is a bottom view of a solid shoe of an embodiment of the present invention.

FIG. 2A is a side view of a pressure fit plug for insertion into holes in shoe.

FIG. 2B is a side view of an embodiment of a shoe of the invention showing a screw type plug for insertion into holes in the shoe.

FIG. 3 is a side view of an embodiment of a shoe of the invention showing a large pressure fit hollow plug for insertion into holes in the shoe.

FIG. 3A is another side view of an embodiment of a shoe of the invention showing a large pressure fit hollow plug for insertion into holes in the shoe.

FIG. 3B is a perspective view of an embodiment of a large pressure fit hollow plug for insertion into holes in the shoe.

FIG. 3C is a side view of an embodiment of a large pressure fit hollow plug for insertion into holes in the shoe.

FIG. 4 is a side view of a shoe structure of an embodiment of the invention illustrating shoe structure that slopes on both to the front and rear.

FIG. 5 is a flow diagram of a treatment protocol using the shoe structure of the invention.

FIGS. 6A and 6B are top views of a shoe having solid substances disposed therein.

FIG. 7 is a perspective view of an alternative shoe shape.

### DETAILED DESCRIPTION OF THE INVENTION

This invention is an equine shoe structure and shoe assembly that provides a cushioning effect on the hoof and legs, covers substantially all the underside of a hoof, provides break-over modification and allows access to the underside of the hoof without removing the shoe. The equine shoe assembly comprises a structure for attachment to the underside of an equine hoof that allows the hoof to rock forward—break-over—when tilted, as by movement of the equine leg thus allowing the equine to find a naturally comfortable position. The shoe has relatively small opening(s) extending through the structure from the underside to the top for insertion of medication or support material and plugs (preferably removable) to close the openings.

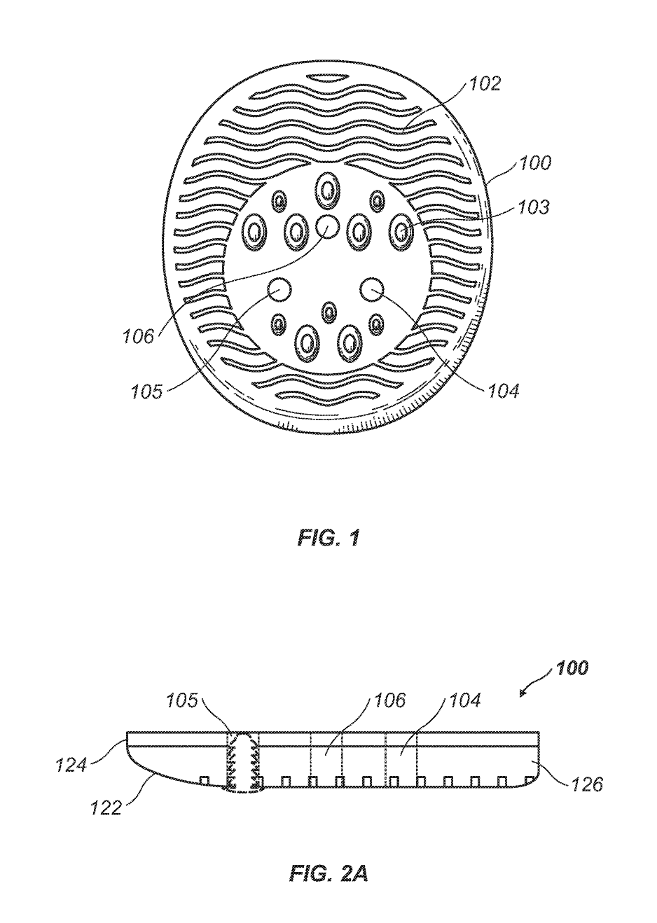

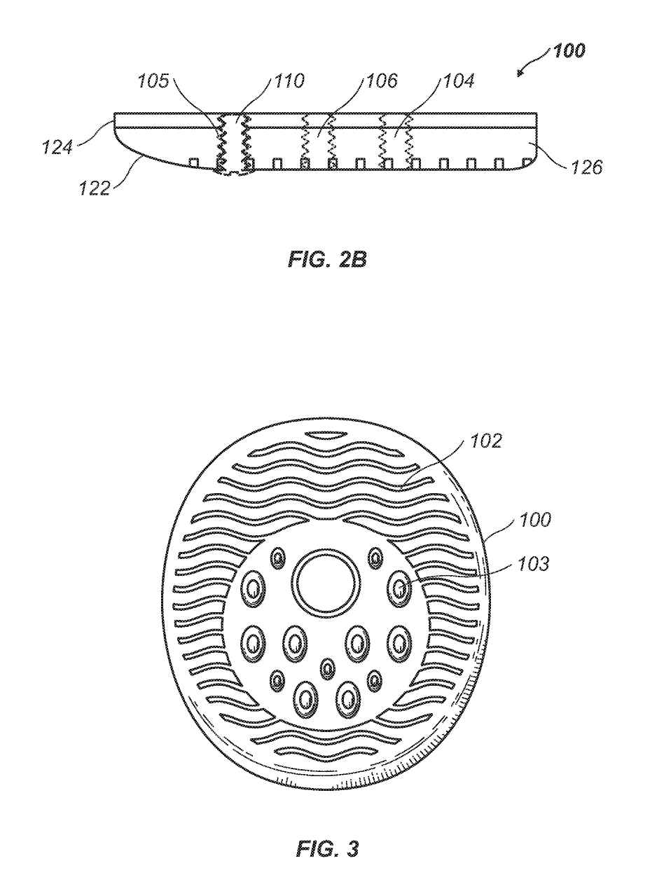

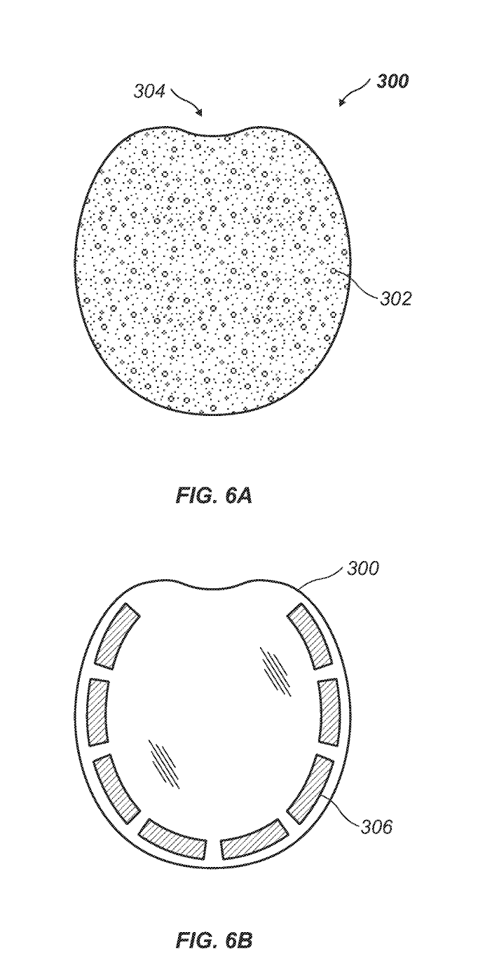

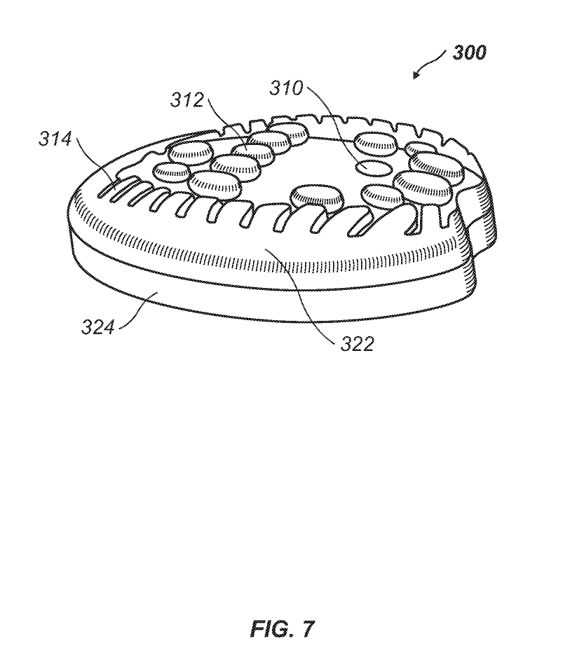

The shoe structure (FIG. 1-4, and FIG. 6-7) has a sloping front to allow it to tip forward from a point desirably located below a point near the front of the distal P phalanx, P3 (coffin bone). One shape is shown in FIG. 1-4 and an alternative shape illustrated in FIG. 6-7. In general, it is desirable that the break-over be within 1-2 inches, front to back, on the shoe from the front point of P3. The ideal point, in most cases will be at or within ½ inch of the front of the P3. A convenient way to locate the front of the coffin bone is draw a perpendicular line down from the hair line of the coronet band of the hoof; where this line intersects the rocker attachment will be the ideal break-over point. The angle of slope is generally from about 15 to 45 degrees and preferably about 30 degrees. The shoe may also be sloped in the rear in the same manner as the front. The shoe may be rounded in the rear (FIGS. 2A and 2B) or as shown in FIG. 4 where it is sloped in front and rear making a somewhat symmetrical (front to back) “rocker”. This double sloped structure is less stable and requires the equine to adjust to the “rocking” effect thus providing more exercise and stimulation to the leg and hoof. The shoe bottom may also be sloped from side to side.

This rocker shape is especially beneficial for equine with laminitis in moving the break-over (lever-arm of the hoof) back from the front of the hoof, so that pressure is unloaded from the hoof wall to relieve the hoof lamina from all the work of holding the bony column of the hoof and leg to the furthest point out toward the front of the hoof. Without this “rocker” effect the pressure in on the front hoof wall when the hoof is tilted forward. Longer hooves have an even more pronounced effect. The further forward the break-over is, the more levering there is placed on the foot and potential strain on the entire back portion of the limbs. The rocker shape allows the pressure to be unloaded from the hoof wall. Break-over, as the term is used herein, is the last point of the hoof or shoe to come off the ground when the horse is moving.

Thus, modification of break-over greatly reduces the pressure exerted on the leg, especially with equine with longer hooves. “Horses with a long sloping pastern have a ground reaction force vector that is longer, with larger forces in the tendon. With a longer toe, the ground reaction force moment arms get bigger, and force on the tendon grows. Calculations show that 1 centimeter of toe length in an average Thoroughbred comes to 50 kilos of force acting on the tendons.” Audrey Pavia, “Why Equine Bones Break and Tendons Rupture”; American Farriers Journal, May/June 2016, p-48-54. Moving the break-over can easily have the effect of shortening the hoof length.

An additional advantage of the “rocker” shape is that it greatly reduces the surface area in contact with the ground or other surface onto which the equine stands. For example, a typical shoe may be about 6 inches×6 inches or about 28 square inches. A suitable rocker attachment will be about 4 inches×4 inches or 12.6 square inches which is only about 45% of the surface of the cast bottom. A smaller shoe will reduce ground contact even further. Lateral break-over (sloping from side to side as in some embodiments) eases turning and helps eliminate the rotational torque on the compromised lamina. A tell-tale way to determine if a horse has laminitis is to walk horse in tight turns that exacerbates the disconnected lamina.

The shoe structure of the shoe assembly is laterally shaped like the underside of an equine hoof and is sized to cover the entire hoof underside. The shape and size can be premade to order or, when constructed of a molded elastomer, the shoe may be customized on-site, if desired, to an individual equine hoof shape with standard farrier tools such as a rasp and knives. An advantage of the shoe is that it may be attached by an owner or veterinarian without need of a custom fit by a farrier.

The term solid structure, and solid “rocker”, as used herein means a structure as illustrated in the Figures that is a unitary solid structure that substantially covers the sole (underside) of an equine hoof.

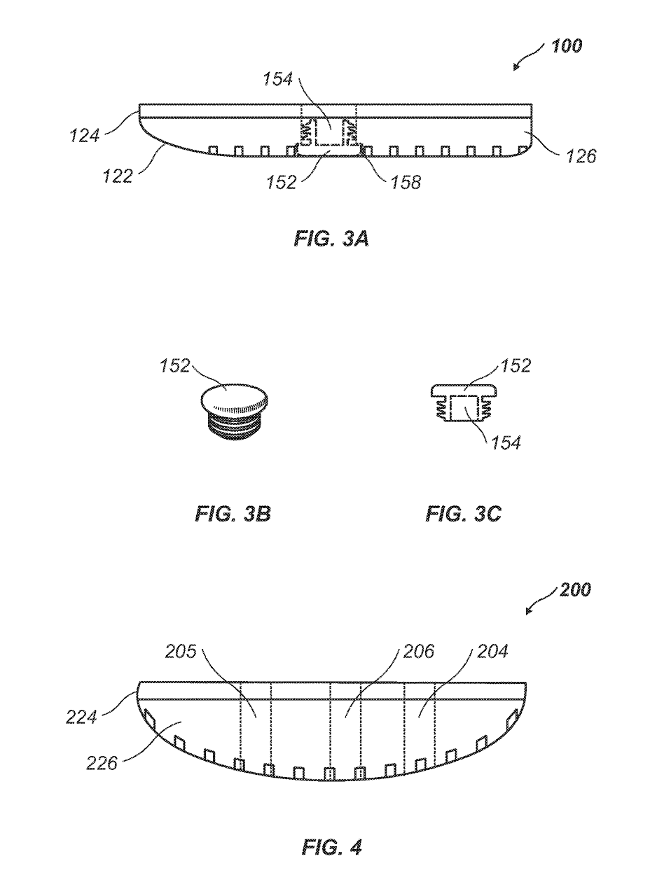

Referring to the figures, FIG. 1 is a bottom view of an embodiment of a shoe structure, 100, of the invention. FIGS. 2A and 2B is a side view of the shoe structure, showing the slope of the underside from the center (front to back) to front, 122, and rounded rear, 10. The drawings shows patterning, 102, and the placement of openings 104,105 and 106. These openings (holes) extend through the shoe structure so that medication or filling can be easily and conveniently inserted or injected, on a routine schedule. The size and placement of the openings will depend upon the intended use. The opening may be any shape but are preferable circular. In general the opening will be round and about 1/16 to 1½ inch in diameter. In the shoe assembly, the openings are sealed by plugs that pressure fit into the openings, or screw plugs with male threads that screw into female threads in the side walls of the openings. The female threads preferably extend into the harder top section of the shoe to make the screw connection more secure. The plugs shown in FIG. 2A are relatively soft “christmas tree” plugs that have flexible ridged sides that compress when inserted. Simple straight pressure fit plugs may also be used. It is also possible to permanently seal the openings, but removable plugs are preferred. The plugs should not generally extend beyond the top surface of the shoe and are preferably be made of polymer material of a hardness of no greater than that of the lower section of the shoe structure. Polyethylene, polypropylene, polyurethane elastomer, silicon rubber and the like are suitable material for the plugs. Acceptable plugs are available commercially from companies like ITW Fastex (www.itw-fastex.com), Apex Fasteners (apexfasteners.com) and StockCap (www.stockcap.com). The plugs will preferably have heads of slightly larger diameter than the principle diameter of the plug, and the opening(s) in the structure will be enlarged at one end (top or bottom of the shoe structure) so that the head of the plug can be recessed, (See, for example, 158 of FIG. 3A). As illustrated the embodiment shown in FIGS. 1 and 2 there are three openings in the shoe structure. The placement is in a triangular pattern that will allow insertion or injection on either side of and in front of an equine hoof frog (when shoe is in place). There may be as many openings as desired but at least one to about four should be sufficient for most purposes. It is important to not compromise the integrity of the shoe structure. The total open space of the opening(s) relative to the surface of the shoe structure should not exceed about 20% and preferable not exceed about 11.2%. A 6 inch diameter shoe structure has a surface area of about 28.3 inches square. Four 1 inch diameter openings (holes) have an open area of about 4×0.8=3.2 inches square inches or about 12% of the shoe surface. The same diameter shoe structure with three 1½ inch opening have about 5.3 inches square opening area or about 18.7% of the surface. Greater openings area will compromise the structural integrity of the shoe and be unsuitable. Conventional shoes have open space of more than about 40% usually as much as 65% open space and have an open back.

FIGS. 3, 3A, 3B and 3C illustrate embodiments with larger hollow plugs (152 with hollow center opening, 154). These are especially useful when it is important to observe a larger area of the hoof sole (or frog) or for insertion of larger medical components such as medication soaked gauze, foams, adsorbent pads and the like. For example, when the larger opening (and plug) is positioned under the frog of the hoof, it is possible to remove the plug and observe to condition of the frog. These plugs can be shorter than the opening, or the same length, but in any case provide a cavity (154) that provides additional space below the hoof for treatment. It is preferred that the opening be enlarged at the bottom to allow the head of the plugs to be receded (158). These are also especially useful in maggot treatment since the maggots can be placed in the plus hollow cavity and additional smaller opening can be used for drainage. Or a smaller hole can be made in the plug for drainage.

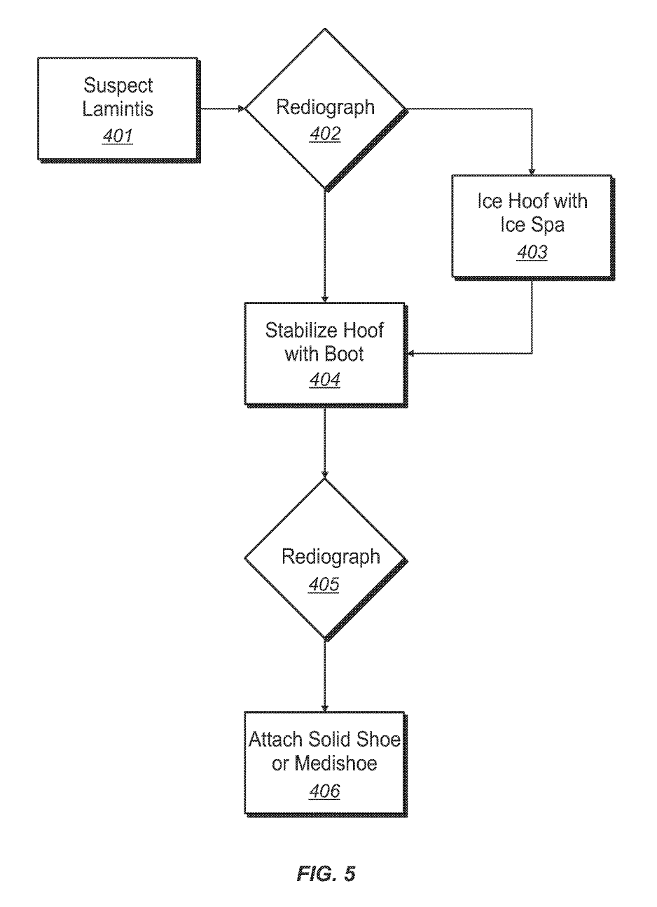

FIG. 5 illustrates a shoe, 200, that is sloped to the front and rear. The structure has a hard top section 224 and softer lower section 226. The underside as shown is patterned (patterning is optional but preferred). Openings 204, 205, and 206 are shown. Various other ways in which the sole of the shoe structure may be sloped are within the scope of this invention. A number of possible shapes are described in co-pending US published application No. 2011/0067366, Mar. 24, 2011 (Ser. No. 12/882,352), incorporated herein by reference for all purposes. The sloped shape on the bottom moves the break-over point back as well as helping isolate the lateral forces on the cast and thereby on the bone column.

The shoe structure, as shown in FIG. 1-4, has a hard section layer (124 in FIG. 2A, 224 in FIG. 4) at the top of the structure and a softer larger section below (126 in FIG. 2A, 226 in FIG. 4). The shoe structure shown has a sloped front (122 or 222). FIG. 4 shows an alternative shoe structure sloped in front (222) and rear (226) making a somewhat symmetrical (front to back) “rocker”.

The hard top section (124, 224) is a layer of about 1/16 to ½ inch layer and should not be so hard as to be brittle and break in use but very rigid compared to the remainder of the shoe. Shore A hardness of about 85 to 100 is suitable for the top section and about 90-95 preferred. It is desirable that the softer lower section of the structure that is in contact with the ground when in use be of Shore A hardness of about 45 to 70 with about 60 being preferred. This softer section helps to cushion the hoof and leg and reduces the extreme concussive force on the legs that exist with metal and hard bottom shoes. The softer lower section also gives the shoe better ground grip. The hard top holds the softer bottom together, stabilizes the structural integrity and provides dimensional integrity and prevents the softer section from spreading laterally and distorting when in use. It also stabilizes an unstable compromised hoof wall. Without the hard section bonded (at interface 124, 224) to the soft section the softer shoe would not be possible. The hard top also provides a more suitable surface for attachment of to the equine hoof. The top can be scored or roughened to provide a better gluing surface. It is preferred that the top section have a hardness similar to the hardness of the equine outside hoof wall as similar hardness materials are more easily glued. The width of the shoe at its widest (measured top surface to bottom surface) is generally about 1 to 1½ inches. The top hard layer of 1/16 to ½ inch will constitute about 5-30% of the total shoe width. A very useful dual density shoe structure is easily produced in an open mold in which the components (as for polyurethane of component composition to give the desired hardness) of the softer section is poured in an open mold, allowed to partially cure then pouring in the components of the harder top section. The bottom of the mold may be designed to provide any desired pattern on the underside of the soft section. The hardness can easily be adapted to the individual need of the horse to which it is applied by selection of the polymer composition and curing conditions.

The shoe assembly can be attached to an equine hoof by conventional nailing, screwing and gluing. Suitable techniques for such attachment are well known in the art. to The shoe may be temporarily attached to the hoof for radiographic study using vet wrap from 3-m or 3 inch wide stretch wrap material such as that available from Uline box company such as the goodwraps mini wrap #S-6141 and dispenser H-761 “cast brand 120 gauge or house brand s-4211. Uline stretch wrap guide is also suitable. In one embodiment a kit will contain a shoe and roll of stretch wrap and suitable glue. With instructions suggesting easy ways for the veterinarian or equine owner to test them on the hoof. Some farriers and veterinarians uses these stretch wraps as a means to smooth out the application of a glue on shoe like the Sigafoos™ shoes while the glue is setting. Suitable glues are readily available and include both acrylic-based glues and urethane-based glues. Both are two-part glues in which curing is achieved by a chemical reaction between the two parts. Equilox™ and Equibond™ are examples of suitable commercial shoe glues. One farrier attaches a prototype the shoe to horse's hooves by screws in the front of the hoof to stabilize the hoof temporarily then wrapping the hoof and sides of the shoe with tradition casting tape. Attaching the shoe with casting tape minimizes damage to the hoof (as could result from nailing the shoe to the hoof) and provides an attachment that can be easily replaced (generally shoes need to be replaced or reset about every 3-6 weeks because of hoof growth). The ease with which the polymer shoe may be shaped and custom fitted to an individual hoof by a common farriers' rasp—no special tools needed is an added advantage.

It is preferred that the top surface be scored or otherwise roughened to facilitate gluing to a hoof. In a prototype, the top of a polyurethane shoe was scored using a very course sandpaper on a belt sander. Any method of preparing the surface to aid in producing a better glue seal is suitable. In applying the shoe the user may use a suitable “pour in pad” such as Vettec Equi-Pak™ or other commercial packing and/or pads that will be placed on the top surface of the shoe between the top surface and underside of the hoof.

In some embodiments the top surface of the shoe will have solid, preferably metals, incorporated where such substances are deemed beneficial for healing of equine hooves as illustrated in FIGS. 6A, 6B and 7. Copper, silver and magnetic metals are generally believed to be beneficial. Particles of copper, silver or magnetic particles may easily be incorporated into the top hard surface of the shoe if the shoe is made in an open mold as shown as 302 in shoe 300 of FIG. 6A. Appropriate amount of particles are poured into the top of the polymer in the mold before it is cured. When such particles are incorporated it is useful to grind or score the surface to expose the surface of the particles. In a prototype a shoe with copper particles was scored with a coarse grain belt sander. This exposes fresh surface of the metal for contact with the hoof underside. Particles of any suitable size and shape may be used, in general relatively flat particles of about 1/16 to ¼ inch in later a diameter are suitable. Cut pieces of copper wire or spheres that have been flattened are suitable. Bands of metal may also be suitably used as illustrated in FIG. 6B where bands 306 are disposed around the edge of shoe 300. Bands pre-molded to the shape of the shoe (but slightly smaller) may be made and placed in the mold before the polymer cures to obtain a smooth continuous (or near continuous) layer of metal on the surface. On the use of silver and silver compounds, see, for example, Uses of Silver as an Antibiotic in Horses, Kentucky Equine Research Staff, Sep. 22, 2011; www.equinews.com/article/uses-silver-antibiotic-horses. FIGS. 6A, 6B and 7 also illustrate an alternate shoe shape having an indention 304 in the back side. This more closely approximates a hoof shape. FIG. 7 also illustrates patterning of the softer lower section (314) of the shoe, where 322 is the edge pattern and 312 are raised dots. 310 is an opening.

In some embodiments UV (Ultra Violet) light LED (Light Emitting Diodes) are placed in one or more hollow plugs and a channel for wired electrical drilled or grooved from the opening to an outside edge of the shoe, preferably the back. The channel is preferable placed just below the hard top section of the shoe. UV light antibacterial effects are well known (see wikipedia—n.wikipedia.org/wiki/Ultraviolet germicidal irradiation). The intensity and duration can be determined buy those skilled in the art. Generally about 30 mJ/cm² is considered effective for destruction of most bacteria. Such a shoe is fitted on an equine and then the equine stalled and the LED light connected for sufficient time to provide antibacterial benefits.

In the illustrative embodiments shown in the Figures, as example of appropriate dimensions, the length—front to back—of the shoe is about 5.5 inches, the width about 5.25 inches, the slope begins about 1.5 inches from the front of the shoe and the thickness of the shoe, at the center, is about 1 to 1½ inches. These dimensions will vary to accommodate shoes for the various sizes and shapes of equine hoofs.

Polyurethanes are particularly suitable materials for the shoe structure as they are easily moldable in open molds or by injection molding. Other polymer materials with similar characteristics as polyurethane, such as polyvinyl chlorides, styrene butadiene styrene polymer, epoxies and the like, are also usable. Choice of these will be well within the ability of those skilled in the polymer art to select.

The solid structure, if made of polymer, may be reduced in weight by adding lower density small particles into the polymer as is illustrated with polymer equine boot orthotics in U.S. patent application Ser. No. 13/396,191, filed Feb. 14, 2012, and U.S. patent Ser. No. 14/046,430 filed Oct. 4, 2013, the disclosures of which is incorporated herein by reference. While the orthotic is generally softer than the shoe structure if this invention the inclusion of lower density particles works in the same way. The particles may be any material with sufficient durability for incorporation into the shoe structure. The particles materials are of lower density than polymer of the shoe structure, must be capable of being adhered to by elastomeric polymer materials (preferably polyurethane), and generally, but optionally, spherical or elliptical in shape. Suitable materials may include, but are not limited to, polymers and elastomers, and preferably expanded foam or cellular formulation of these polymers. Specific examples include polypropylene and expanded polypropylene (PP), polyethylene and expanded polyethylene (PE), high density polyethylene (HDPE), ethylene propylene diene monomer (EPDM), polystyrene (PS), polyurethane and polyurethane foams, polystyrene, polybutadiene, styrene-butadiene rubber (SBR), and polyvinylchloride. In one embodiment, polypropylene and polyethylene are preferred, with closed-cell expanded polypropylene being particularly preferred for its low density, high durability, flexibility, resilience, and thermal insulation.

The particle cross section or diameters are desirably in the range of one (1) to six (6) millimeters (mm) (3.9×10⁻² to 2.4×10⁻¹ inches). In a preferred embodiment, the particles have a diameter of approximately two (2) to four (4) mm (7.9×10⁻² to 1.6×10⁻¹ inches), with approximately three (3) mm (7.9×10⁻² inches) being particularly preferred. Particles of these sizes are small enough to be incorporated into the polymer of the structure and large enough to not unduly increase viscosity of the polymer mixture during molding. If the particles are too large the result is a kind of permanent set reducing the flexibility and compressibility of the molded piece.

One of the key properties of the particles is their low density compared to the polymer of the solid shoe structure, resulting in a lower overall weight-to-volume ratio of the structure. The difference in density between the particles and the polymer in the structure causes the particles to rise towards the top of an open mold during casting, which becomes the bottom of the member. The shoe will have a top harder section as described above that does have particles and will be poured on top of the softer section with particles in an open mold. The relative densities of the particles and polymer of the structure may be varied to control the relative positions of elastomer and particles. The particles also increase the thermal insulation quality of the shoe.

The density of the particles is desirably in the range of about twenty (20) to five hundred twenty (520) grams/liter (g/l). For example, expanded polypropylene beads have a density range of about ten to two hundred (10-200) g/l, and preferred mid density beads have a density range of from about forty to one hundred twenty (40-120) g/l. Suitable polyurethane for the structure have densities of about one thousand twenty-five to one thousand seventy (1025-1070) g/l, so the ratio of density of polymer in the structure to particle will be in the range of from about eight to twenty-eight (8-28). It is preferred that the particles be at least half the density of the lower polymer structure and preferably no more than about 30% as dense.

In broad aspect, the method for manufacturing the lighter solid shoe structure comprises mixing particles with one or more elastomer component during curing to form a molded piece. The basic process is to mix the elastomer components and catalysts, and to disperse the particles in unset polymer during curing while the polymer is still substantially in the liquid state. A mold of the desired size and shape is filled with the resulting mixture and the mixture is allowed to set and cure.

In some embodiments the structure of the shoe lower section will have fiber incorporated into it. Fibers such as those used in reinforcing cement are suitable. For example, fibers such as polypropylene, cellulose, carbon are suitable. Ultra-high density polyethylene (Dyneema™ and Spectra™) are especially suitable for strength and durability. The amount of fiber in the lower (soft) section of the shoe must be controlled to prevent the structure from becoming too hard and the amount of fiber will depend on a number of factors, particularly the composition of the material of the structure and the hardness desired. The proper amount can easily be determined by simple experiment. Powered Teflon™ may also be added to the structure composition to increase its strength and durability. The Teflon added to the elastomeric urethane is very abrasive resistant and is especially applicable for hard aggregate race tracks like those used in standard bred harness racing.

### Hoof Treatment Uses of the Shoe Assembly

The opening(s) in the shoe allow access to the sole of the hoof so that medications may be applied without removing the shoe. With the shoe attached, filler material may be injected to provide complete support to the underside of the hoof. This is similar to the technique used with convention shoes but with the added enclosure and better protection from dirt, mud and the like and from damage of the filling material. Suitable filling include Vettec Equi-Pak (Vettec Hoof Care—http://www.vettec.com) and similar products.

Medication for hoof diseases and ailments as for Thrush may also be injected. The larger hollow plugs of FIG. 3 provide convenient means for Maggot treatment (maggots can be placed in the hollow section of the plugs, removed for cleaning. Drainage can be accomplished with small holes in the shoe or in the head of the hollow plugs.

Thrush is a bacterial infection that is fairly easily treated with a plethora of treatments, liquids, powders and salves. (See the article at www.thehorse.com/videos/30728/identifying-and-treating-thrush-with-dr-scott-morrison). Any compound that will kill the bacteria such as dilute bleach or dilute chlorhexidine or povidone iodine bleach, iodine, silver compounds a such as silver nitrate etc. is effective. Drying agents such as copper naphthenate (Kopertox) or an isopropanel formalin, iodine complex, and gentian-violet combination (Thrush Buster) are also used in conjunction with the other bacteria killing agents. See “Thrush Treatment Summary”, an article at http://www.healthyhoof.com for a listing of the various compounds and treatment protocols for Thrush treatment. For the purpose of this invention any of these compounds may be injected, replaced and debris removed through the openings in the shoe without the damaging effects of removing and replacing the shoe. The plugs seal the opening to keep the medication in place and to keep the hoof clean and dry.

There is revival of interest in use of maggot debridement for a number of equine hoof conditions. Maggot debridement by certain species of maggots is specific for necrotic tissue and results partly from the maggot's proteolytic digestive enzymes liquefying the necrotic tissue and partly from the physical action of the mouth hooks on the tissue, which pierce and tear the necrotic tissue, allowing the digestive enzymes to reach the depths of the necrotic tissue. “In horses, maggot debridement therapy is described as an alternative approach to the management of septic navicular bursitis, hoof infections and necrosis in cases of complicated laminitis (Morrison S E. How to use sterile maggot therapy. Proceedings 51st Congress of AAEP, Seattle, 2005), PIII osteomyelitis and other hoof disease (Jurga F. and Morrison S E., Maggot Debridement Therapy. Alternative therapy for hoof infection and necrosis. Hoofcare and lameness 2004; 78: 28-31. Dr. Robert Agne, DVM, of Rood and Riddle Equine Hospital; Lexington, Ky. describes the procedure for hoof bio-surgery as follows: “ . . . we must ensure that if the maggots are placed in the bottom of the foot they are not compressed to tightly when the horse is weight bearing. Occasionally, the defect in the sole of the hoof is large enough that we can place the maggots, along with the dressing in the wound and apply a heavy foot wrap. Otherwise a shoe is applied that has a plate that offers wound protection and can be removed in order to change the gauze and monitor the progress of the maggots. The shoe assembly works well for maggot therapy by allowing access to the hoof through the, properly placed holes with hollow larger plugs. If desired there can be a spacer applied between the shoe and hoof to provide additional space. Other treatment and medication protocols will be apparent to those skilled in the art.

### Kit

In some embodiments the invention is a kit of components as that is the way in which some embodiments will likely be merchandized. The kit comprises the shoe assembly as described in detail above (dual density, rocker shoe structure with opening for access and plugs appropriately sized for the opening) The kit may also include suitable glue to attach the shoe structure, drill bits to drill initial or additions holes and instruction sheets.

### Method for Treatment of Equine Laminitis

Laminitis is a costly disease for equine owners. Many better known and famous racehorses have had to be put down because of laminitis and there is a continuing search for a causes and cures. Chronic laminitis most commonly involves the distal displacement (rearward movement/rotation and sometimes sinking) due primarily to trauma, insult or swelling of the lamina (attachment tissue) of the P3 (coffin bone or distal phalanx) to the hoof wall. The deep digital flexor tendon, (doing its job), continues to keep tension on the boney column and further pulls the P3 out of the ideal position within the hoof capsule, resulting in an alignment shift of the weight-bearing functionality of the P3 from its solar surface (bottom of bone should be parallel to the ground surface). This realignment, results in chronic pain and over time decreased sole growth (contracted heels etc.). Many realignment techniques of the P3 cannot be achieved during the initial developmental stages of laminitis because the hoof capsule is unstable and continually changing. Many traditional mechanical realignment procedures like therapeutic trimming or special shoes have been very problematic, painful and traumatic to the horse; are expensive and do not achieve the successful outcomes the horse owners desire.

Referring to FIG. 5 (a diagrammatic representation of the steps of the method), If laminitis is suspected (402) it may be confirmed by radiograph of the hoof. If confirmed the equine hoof will respond to and often laminitis can be prevented by icing the effected hooves (403) as described in U.S. Pat. No. 9,055,732, issued Jun. 16, 20016, the disclosure of which is incorporated herein by reference. After icing, or if icing is not possible or practical under the circumstances, the hoof or hooves will be stabilized by use of an equine boot with an adjustable heel lift wedge (See U.S. patent application U.S. Ser. No. 15/082,749 filed Mar. 28, 2016, the disclosure of which is incorporated herein by reference). The fit in the boot and desirable angle (comfortable angle for the equine) can be adjusted by reference to radiographs (405) until the hoof or hooves are suitably stabilized. When stabilized, the hoof or hooves are fitted with a solid shoe (406) as described in U.S. patent application Ser. No. 15/138,002, filed Apr. 25, 2016 and in U.S. patent application Ser. No. 15/051,343 filed Feb. 23, 2016, the disclosures of which is incorporated herein by reference or, preferably, a shoe adapted for medication application as described herein.

### Radiographs (402,405 of FIG. 5)

Radiographs have become a common and essential tool in diagnosing hoof ailments. Examples of radiograph use and improvements include, inter alia, US examples include U.S. Pat. No. 8,413,73, U.S. Pat. No. 7,716,843, U.S. Pat. No. 7,088,8417 and application US 2013/0129056. It is well established that early treatment of laminitis is critical. Researchers and practitioners agree that frog support is needed and that relief of the tension on the coffin bone by the deep digital flexor is essential—thus lifting the heel of the hoof to increase the angle of the diseased hoof is important. The Horse: Your guide to Equine Health Care, 2009 Blood Horse Publications. Regarding hoof treatment of laminitic equine, it has been said “Many farriers feel that supporting the frog is of immediate concern as soon as symptoms are noticed. Support can be given by padding up around the frog with gauze bandages or a commercially available “lily pad”™ which can be fitted whilst a horse is still wearing shoes. Immediate pain relief can be offered by using a wedge to raise the heel, thus relieving pressure from the toe area. Raising the heel reduces the pull on the rear of the pedal bone and may help to minimize further lamellar tearing.” See The Cyberhorse Guide to Horse Health; www.cyberhorse.net.au/cgi-bin/tve/displaynew sitem.pl?20040325laminitispt3.txt.

### Heel Lift Wedge Boot (404 of FIG. 5)

The wedge heel lift boot of application Ser. No. 15/051,749, filed Mar. 28, 2016 provides an efficient, lift adjusting approach to sole supportive realignment of the P3 as the hoof grows out. This equine boot system and assembly provides a heel lifting adjustable wedge to lift the heel section of an equine hoof to relieve and reduce the consequences of laminitis and optionally to provide frog support. Lifting the heel is useful in reducing the tension on the deep digital flexor tendon (DDFT).

### Rocker Shoes (406 of FIG. 5)

It is also considered important to provide means to allow the laminitic equine to be able to reduce hoof pressure from sharp break-over of the hoof when walking and to allow it to find its own most comfortable standing position as explained above. This is accomplished by “rocker” shoe sloped underside.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept. The specification and drawings are, accordingly, to be regarded in an illustrative rather than a restrictive sense. Therefore, the scope of the invention should be limited only by the appended claims.

1. An equine shoe assembly comprising:
a.) a solid structure having a top surface and a bottom surface wherein the solid structure has a top section of hard material of at least 90 Shore A hardness and a lower section of a Shore A hardness of about 45 to 65 and having at least one opening extending from the top surface to the bottom surface of the structure and
b.) plug or plugs that fit into and seal the opening or openings.

2. The shoe assembly of claim 1 wherein the solid structure has a front and rear and the bottom surface is sloped toward the front and rounded at the rear, the slope being from the centerline of the member.

3. The shoe assembly of claim 1 wherein the solid structure has a front and rear and the bottom surface is sloped from the centerline of the member toward the front and rear.

4. The shoe assembly of claim 1 wherein the plugs are of material no harder than the lower section of the structure, have an opening surface area no greater than 20% of the surface area of the solid structure and are selected from the group consisting of hollow center plugs, plugs with ribbed flexible sides, smooth sides and plugs with threads.

5. The shoe assembly of claim 1 wherein the solid structure is made of polyurethane.

6. The shoe assembly of claim 1 wherein the solid structure has topside and underside and the underside of the solid member is patterned by a series of ridges and grooves.

7. The shoe assembly of claim 1 wherein the top section of the solid structure is between 5-30% of the width of the shoe structure measured from the top surface to the bottom surface.

8. The shoe assembly of claim 1 wherein the solid structure has incorporated therein particles of lower density to reduce the weight of the solid member.

9. The shoe assembly of claim 8 wherein the particles have a diameter or cross section of about 2 to 4 mm and a density no greater than about 30% of the density of the polymer of lower section of the shoe solid structure.

10. The shoe assembly of claim 1 wherein the top surface of the solid structure has particles of solid materials incorporated therein.

11. The shoe assembly of claim 10 wherein the solid particles are selected from the group consisting of copper, silver and compounds of copper and of silver.

12. The shoe assembly of claim 1 wherein opening have UV light emitting devices disposed therein.

13. The shoe assembly of claim 10 wherein the solid particles and top shoe surface scored after incorporation.

14. An equine shoe comprising a solid structure having a top surface and a bottom surface wherein the solid structure has a top section of hard material of at least 90 Shore A hardness and a lower section of a Shore A hardness of about 45 to 65 and having at least one opening extending from the top surface to the bottom surface of the structure.

15. The equine shoe of claim 14 wherein the solid structure has a front and rear and the bottom surface is sloped toward the front and the rear is rounded or the bottom surface is sloped toward the bottom surface is sloped from the centerline of the member toward the front and rear.

16. A method of treatment the hoof or hooves of equine with laminitis comprising:
a.) radiographing the hoof or hooves of an equine suspected of having laminitis;
b.) if laminitis is confirmed placing the hoof or hooves in an ice bath;
c.) following icing in an ice bath placing the hoof or hooves in a boot having an adjustable and using additional radiograph results position the hoof or hooves in a desired comfortable position to stabilize the hoof or hooves; and
d.) attach a solid shoe the hoof or hooves.

17. The method of claim 16 wherein the solid shoe of d.) comprises a solid structure having a top surface and a bottom surface wherein the solid structure has a top section of hard material of at least 90 Shore A hardness and a lower section of a Shore A hardness of about 45 to 65 and having at least one opening extending from the top surface to the bottom surface of the structure.

18. The method of claim 16 wherein the solid shoe of d.) has incorporated therein particles of lower density to reduce the weight of the solid member said particles having a diameter or cross section of about 2 to 4 mm and a density no greater than about 30% of the density of the polymer of lower section of the shoe solid structure.

19. The method of claim 17 wherein the top surface of the solid shoe of d.) particles or strips of solid materials incorporated therein said particles are selected from the group consisting of copper, silver and compounds of copper and of silver.
